(19) United States
(12) Patent Application Publication
(10) Pub. No.: US 2011/0047729 A1
(43) Pub. Date: Mar. 3, 2011

(54) ELECTRIC TOOTHBRUSH

(75) Inventors: Toshiyuki Iwahori, Mishima-gun (JP); Akitoshi Miki, Ibaraki-shi (JP)

(73) Assignee: OMRON HEALTHCARE CO., LTD., Kyoto-shi, Kyoto (JP)

(21) Appl. No.: 12/990,543

(22) PCT Filed: May 15, 2009
(86) PCT No.: PCT/JP2009/059066

§ 371 Date: Nov. 1, 2010

(30) Foreign Application Priority Data
May 19, 2008 (JP) 2008-131150

(51) Int. Cl. A61C 17/34

(52) U.S. Cl. 15/22.1

(57) ABSTRACT

An electric toothbrush capable of greatly vibrating a brush with less vibration by a vibration source is provided. An electric toothbrush includes a cylindrical case; and a vibration body having one end located within case and the other end provided so as to protrude through an opening at the tip of the case to the outside of the case and vibrating a brush located in proximity to the other end. Vibration body is provided with a vibration source on the one end side and has an outer peripheral surface supported in the position close to the vibration source side with respect to the midpoint in the longitudinal direction of vibration body.

### TECHNICAL FIELD

The present invention relates to an electric toothbrush.

### BACKGROUND ART

Conventionally, an electric toothbrush is known that is configured to provide a vibration source within the body of a toothbrush for transmitting vibration to a brush (see Patent Documents 1 and 2). In such an electric toothbrush, for example, the techniques for improving the vibration transmission efficiency and producing resonance are used in order to efficiently vibrate the brush.

However, the above-described techniques tend to complicate the mechanism for transmitting vibration or make it difficult to reduce the dimension of the portion around the brush part. Accordingly, there is a need for a technique for more greatly vibrating a brush with less vibration in a vibration source.

### PRIOR ART DOCUMENTS

### Patent Documents

### Patent Document 1: Japanese Registered Utility Model No. 3008856

### Patent Document 2: Japanese Patent Laying-Open No, 10-192054

### SUMMARY OF THE INVENTION

### Problems to be Solved by the Invention

An object of the present invention is to provide an electric toothbrush capable of causing great vibration of a brush with less vibration by a vibration source.

### Means for Solving the Problems

The present invention employs the following means for solving the above-described problems.

An electric toothbrush of the present invention includes a cylindrical case; and a vibration body having one end located within the case and an other end provided so as to protrude through an opening at a tip of the case to outside of the case and vibrating a brush located in proximity to the other end. The vibration body is provided with a vibration source on the one end side and has an outer peripheral surface supported in a position close to the vibration source side with respect to a midpoint in a longitudinal direction of the vibration body.

According to the present invention, the vibration body provided with a vibration source on the one end side has an outer peripheral surface supported in the position close to the vibration source side with respect to the midpoint in the longitudinal direction of the vibration body. Consequently, the vibration of the vibration source causes the vibration body to be vibrated in the position as a supporting point at which the vibration body is supported. Since, the distance from the supporting point to the other end is longer than the distance from the supporting point to the vibration source, the other end is vibrated more greatly than the vibration source. In other words, the vibration caused by the vibration source is amplified and transmitted to the other end side.

Thus, the vibration body according to the present invention allows the vibration of the vibration source provided on the one end side to be amplified and transmitted to the other end (in proximity to the brush), thereby allowing the brush to be greatly vibrated with less vibration caused by the vibration source.

It is preferable that the vibration source includes a motor fixed on the one end side of the vibration body and a weight attached to a rotation shaft of the motor and having a center of gravity in a position displaced from a rotation center of the rotation shaft.

Consequently, the vibration body vibrates so as to cause a pivotal movement of the one end side.

Furthermore, it is preferable that the weight is attached on the one end side of the motor.

It is preferable that a position restricting portion for restricting movement of the vibration body toward the one end side while permitting vibration of the vibration body is provided within the case.

Consequently, the vibration body can be prevented from moving toward the one end side.

It is preferable that a vibration damping structure for suppressing transmission of vibration of the vibration source to the case is provided within the case.

Consequently, the transmission of the vibration to the case can be suppressed.

It is preferable that the electric toothbrush includes an eccentric shaft including a shaft body and a weight fixed to the shaft body and having a center of gravity located in a position displaced from a shaft center; and a driving source rotating the eccentric shaft. The vibration body includes a hollow member, a bearing is provided in proximity to a tip on the other end side within the hollow member, and the eccentric shaft is supported by the bearing.

Consequently, since the eccentric shaft causes vibration on the other end side of the vibration body, the other end side of the vibration body can be further greatly vibrated.

It is preferable that the center of gravity of the weight of the eccentric shaft is located in a position displaced by approximately 180° from the center of gravity of the weight included in the vibration source with respect to the rotation center.

Consequently, the other end side of the vibration body can be effectively vibrated.

It is to be noted that the above-described configurations can be employed in every possible combination.

### EFFECTS OF THE INVENTION

As described above, the present invention allows a brush to be greatly vibrated with less vibration caused by a vibration source.

### BRIEF DESCRIPTION OF THE DRAWINGS

FIG. 1 is a partial cutaway perspective view of an electric toothbrush according to the first embodiment of the present invention.

FIG. 2 is a partial enlarged view of FIG. 1.

FIG. 3 is a diagram of an internal configuration of the electric toothbrush according to the first embodiment of the present invention.

FIG. 4 is a schematic cross-sectional view showing a main component part of the electric toothbrush according to the first embodiment of the present invention.

FIG. 5 is a diagram for illustrating the state of vibration transmission in the electric toothbrush according to the first embodiment of the present invention.

FIG. 6 is a partial cutaway perspective view of an electric toothbrush according to the second embodiment of the present invention.

FIG. 7 is a schematic cross-sectional view showing a main component part of the electric toothbrush according to the second embodiment of the present invention.

FIG. 8 is a schematic cross-sectional view showing a main component part of an electric toothbrush according to the third embodiment of the present invention.

FIG. 9 is a schematic cross-sectional view showing the main component part of the electric toothbrush according to the third embodiment of the present invention.

FIG. 10 is a schematic cross-sectional view showing a main component part of an electric toothbrush according to the fourth embodiment of the present invention.

FIG. 11 is a diagram of an internal configuration of an electric toothbrush according to the fifth embodiment of the present invention.

FIG. 12 is a schematic cross-sectional view showing a main component part of the electric toothbrush according to the fifth embodiment of the present invention,

FIG. 13 is a diagram for illustrating the state of vibration transmission in the electric toothbrush according to the fifth embodiment of the present invention.

FIG. 14 is a schematic cross-sectional view showing a main component part of an electric toothbrush according to the sixth embodiment of the present invention.

FIG. 15 is a schematic cross-sectional view showing a main component part of an electric toothbrush according to the seventh embodiment of the present invention.

FIG. 16 is a schematic cross-sectional view showing the main component part of the electric toothbrush according to the seventh embodiment of the present invention.

### MODES FOR CARRYING OUT THE INVENTION

The modes for carrying out the present invention will be hereinafter described in detail based on embodiments by way of example with reference to the accompanying drawings. It is to be noted that size, material, shape, relative arrangement and the like of the components described in the embodiments are not intended to limit the scope of the present invention thereto unless otherwise defined herein. In the following description, the terms “one end side” and “the other end side” represent the side opposite to that having a brush provided thereon (the side gripped by a hand during toothbrushing) and the side having a brush provided thereon, respectively, in the longitudinal direction of the electric toothbrush.

### First Embodiment

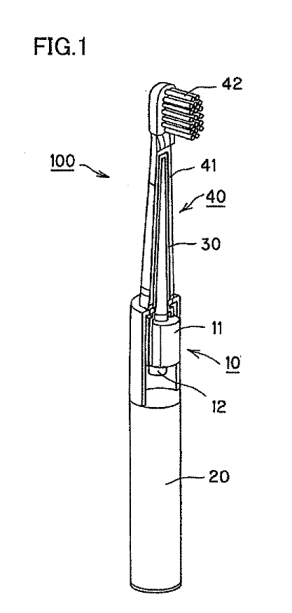

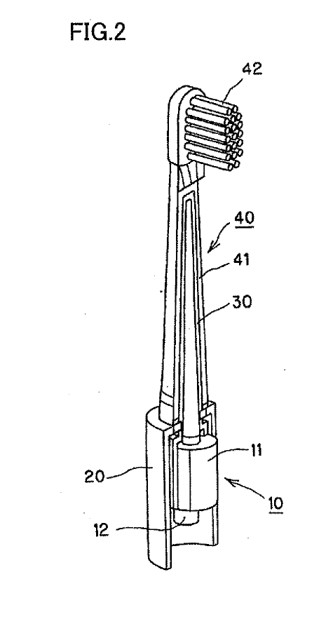

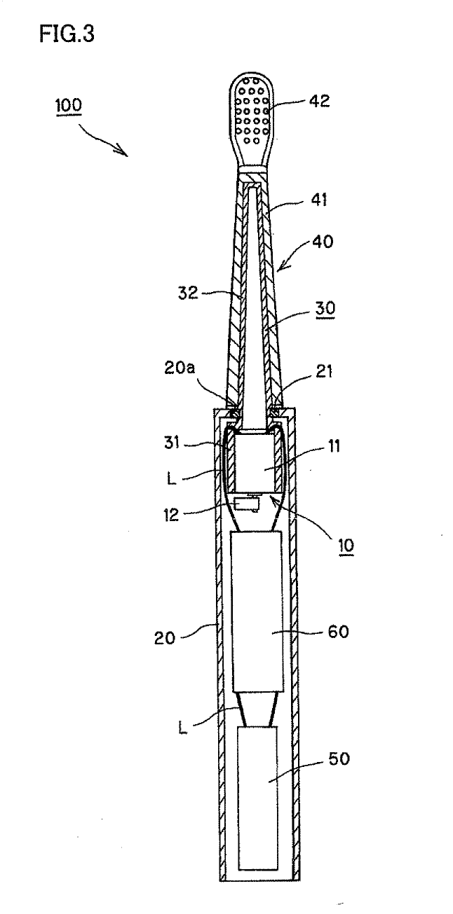

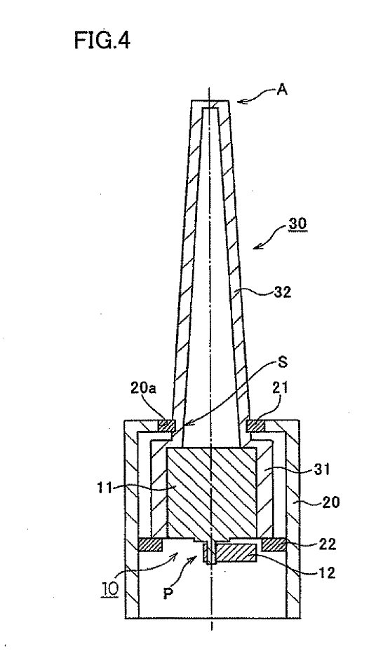

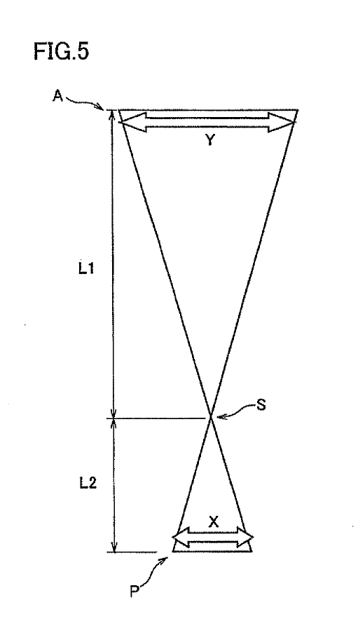

Referring to FIGS. 1 to 5, an electric toothbrush according to the first embodiment of the present invention will be hereinafter described. FIG. 1 is a partial cutaway perspective view of an electric toothbrush according to the first embodiment of the present invention. FIG. 2 is a partial enlarged view of FIG. 1. FIG. 3 is a diagram of an internal configuration of the electric toothbrush according to the first embodiment of the present invention. FIG. 4 is a schematic cross-sectional view showing a main component part of the electric toothbrush according to the first embodiment of the present invention. FIG. 5 is a diagram for illustrating the state of vibration transmission in the electric toothbrush according to the first embodiment of the present invention.

[Overall Electric Toothbrush]

Particularly referring to FIGS. 1 to 4, the configuration and the like of the overall electric toothbrush according to the first embodiment of the present invention will then be described. An electric toothbrush 100 according to the first embodiment of the present invention includes a cylindrical case 20 corresponding to a portion gripped by a hand during toothbrushing, a vibration body 30, and a brush part 40 attached to vibration body 30. Vibration body 30 has one end located within case 20 and the other end provided so as to protrude through an opening 20a at the tip of case 20 to the outside of the case.

Brush part 40 is attached so as to cover this vibration body 30. Brush part 40 has a body part 41 which is made of a cylindrical member such that it can be attached to vibration body 30. At the end of body part 41, a brush 42 is provided. It is to be noted that this brush part 40 is consumable, and thus, configured to be attachable to and detachable from vibration body 30 in order to allow exchange of the part with a new one as appropriate.

Case 20 is provided inside with a battery (rechargeable battery) 50 serving as a power supply and a circuit board 60 performing drive control of a vibration source 10 described below. Furthermore, an annular support member 21 supporting the outer peripheral surface of vibration body 30 is provided at the inner peripheral edge of opening 20a of case 20. In the present embodiment, an annular groove is formed at the outer periphery of vibration body 30 and the inner peripheral edge of support member 21 is fit into this annular groove. Consequently, vibration body 30 is supported and positioned by support member 21. Furthermore, this support member 21 not only supports vibration body 30 but also performs a function as a seal for preventing water and the like from coming into case 20. Accordingly, it is necessary to use a material having an appropriate hardness for a material of this support member 21 in order to achieve both of the supporting function and the waterproof function. Thus, in the present embodiment, an elastomer is employed as a material of support member 21. Furthermore, as shown in FIG. 3, a wiring line L electrically connects between battery 50 and circuit board 60, and between circuit board 60 and a motor 11 which is a component of vibration source 10.

Vibration body 30 is formed of a cylindrical hollow member. Vibration body 30 includes a cylindrical portion 31 provided on its one end side and a tapered portion 32 integrally provided in cylindrical portion 31 and tapered toward the other end side. Furthermore, vibration source 10 is provided in cylindrical portion 31 on the one end side of vibration body 30, Vibration source 10 includes motor 11 fixed in the state where it is inserted into cylindrical portion 31 and a weight 12 attached to the rotation shaft of motor 11. In this case, weight 12 is configured to have the center of gravity in the position displaced from the rotation center of the rotation shaft of motor 11. It is to be noted that weight 12 is provided on the one end side of motor 11.

Furthermore, vibration body 30 is in contact with an annular member 22 fixed to the inner peripheral surface of case 20 and is restricted in movement toward the one end side in order to prevent the movement toward the one end side. In other words, this annular member 22 serves as a position restricting portion. In addition, since vibration body 30 is merely in contact with annular member 22, vibration body 30 can be freely moved along the plane orthogonal to the shaft center (pivoting plane) in its longitudinal direction, which allows vibration (see FIG. 4. It is to be noted that annular member 22 is not shown in FIGS. 1 to 3 for the sake of explanation.). Furthermore, vibration body 30 is supported at its outer peripheral surface by support member 21 as described above in the position close to the vibration source 10 side (the one end side) with respect to the midpoint in the longitudinal direction of vibration body 30.

### [Explanation of Operation of Electric Toothbrush]

Particularly referring to FIGS. 4 and 5, electric toothbrush 100 according to the first embodiment of the present invention will be hereinafter described.

When electric toothbrush 100 is powered on, the rotation shaft of motor 11 is rotated to cause rotation of weight 12 attached to this rotation shaft, As described above, weight 12 has the center of gravity in the position displaced from the rotation center of the rotation shaft of motor 11. Accordingly, rotation of weight 12 produces a centrifugal force, which causes vibration body 30 to be vibrated such that the one end side is pivotally moved.

FIG. 5 schematically shows the state where vibration body 30 vibrates (pivots). The part indicated by an arrow P in FIG. 5 corresponds to the part on one end of vibration body 30, as indicated by an arrow P also shown in FIG. 4. Furthermore, a reference character X in FIG. 5 shows a pivot diameter at one end of the central axis of vibration body 30 at the time when vibration body 30 is pivotally moved. Furthermore, the part indicated by an arrow S in FIG. 5 corresponds to the part in vibration body 30 supported by support member 21, as indicated by an arrow S also shown in FIG. 4. The part indicated by an arrow A in FIG. 5 corresponds to the part on the other end of vibration body 30 as indicated by an arrow A also shown in FIG. 4. Furthermore, a reference character Y in FIG. 5 shows a pivot diameter at the other end of the central axis of vibration body 30 at the time when vibration body 30 is pivotally moved.

The positional displacement of the part indicated by arrow S in vibration body 30 is prevented by support member 21. Accordingly, the pivot diameter of the central axis in this part is theoretically zero. Vibration body 30 then pivotally moves in the state where the part S supported by this support member 21 is set as the center of the movement. During the pivotal movement, the positional relationship is maintained such that the one end and the other end of the central axis are displaced by 180 degrees from each other with respect to the pivot center axis. The ratio between a pivot diameter Y and a pivot diameter X is theoretically equal to the ratio between a distance L1 from the supported part S to part A on the other end and a distance L2 from the same part S to part P on the one end in vibration body 30 (Y:X L1:L2).

In the present embodiment, as described above, vibration body 30 is supported at its outer peripheral surface by support member 21 in the position close to the vibration source 10 side (the one end side) with respect to the midpoint in the longitudinal direction of vibration body 30. Accordingly, assuming that L1>L2, the result is Y>X.

As described above, when the one end side of vibration body 30 is pivoted (vibrated) by vibration source 10, the other end side of vibration body 30 can also be pivoted (vibrated). Consequently, brush part 40 attached to vibration body 30 is also vibrated. In particular, brush 42 can be greatly vibrated that is located near the other end pivoted (vibrated) most greatly in vibration body 30. In this way, the vibration of vibration source 10 can be transmitted to brush 42 to allow brushing of teeth by placing brush 42 on the teeth.

### Advantages of the Present Embodiment

As described above, in electric toothbrush 100 according to the present embodiment, vibration body 30 provided with vibration source 10 on its one end side is supported at its outer peripheral surface by support member 21 in the position close to the vibration source 10 side with respect to the midpoint in the longitudinal direction of vibration body 30. Accordingly, the vibration of vibration source 10 causes vibration body 30 to be vibrated (pivoted in the present embodiment) in the position as a supporting point at which vibration body 30 is supported by support member 21. Assuming that L1>L2 as described above, the vibration on the other end of vibration body 30 is greater than that of vibration source 10. In other words, the vibration by vibration source 10 is amplified and transmitted to the other end side. In this way, according to vibration body 30 in accordance with the present embodiment, vibration of vibration source 10 provided on the one end side can be amplified and transmitted to the other end (near brush 42), Therefore, brush 42 can be greatly vibrated with less vibration by vibration source 10.

Furthermore, in vibration source 10 according to the present embodiment, weight 12 is provided on the one end side of motor 11. Accordingly, weight 12 is disposed on the side corresponding to an open end of vibration body 30, which leads to an advantage that the state where weight 12 is attached can be readily checked. Furthermore, when changing the manner of vibration, weight 12 can be changed and adjusted even after completion of assembly of vibration body 30. Furthermore, the type of attached weight 12 can also be visually recognized. It is to be noted that weight 12 may be formed in the shape of a blade to produce airflow within case 20 for cooling the inside of case 20.

### Second Embodiment

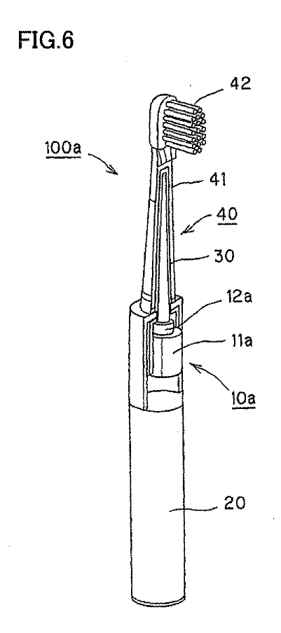

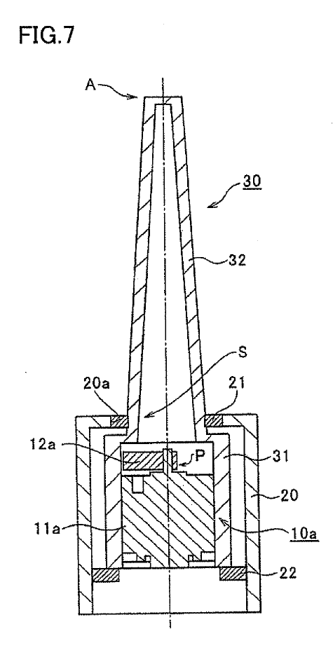

FIGS. 6 and 7 each show the second embodiment of the present invention. The first embodiment as described above describes the case where a weight is provided on the one end side of the motor, whereas the present embodiment will describe the case where the weight is provided on the other end side of the motor. Since other configurations and operations are the same as those in the first embodiment, the same components are designated by the same reference characters, and the description thereof will not be repeated.

FIG. 6 is a partial cutaway perspective view of the electric toothbrush according to the second embodiment of the present invention. FIG. 7 is a schematic cross-sectional view showing a main component part of the electric toothbrush according to the second embodiment of the present invention.

Also in an electric toothbrush 100a according to the present embodiment, a vibration source 10a includes a motor 11a fixed in the state where it is inserted into cylindrical portion 31 in vibration body 30 and a weight 12a attached to the rotation shaft of motor 11a. The present embodiment is different from the above-described first embodiment only in that weight 12a is provided on the other end side of motor 11a.

Also in electric toothbrush 100a according to the present embodiment, the rotation of weight 12a causes a pivotal movement of the one end side of vibration body 30, in which case the operation similar to that in the above-described first embodiment is performed. Therefore, the effects similar to those obtained in the above-described first embodiment can be achieved also in the present embodiment.

### Third Embodiment

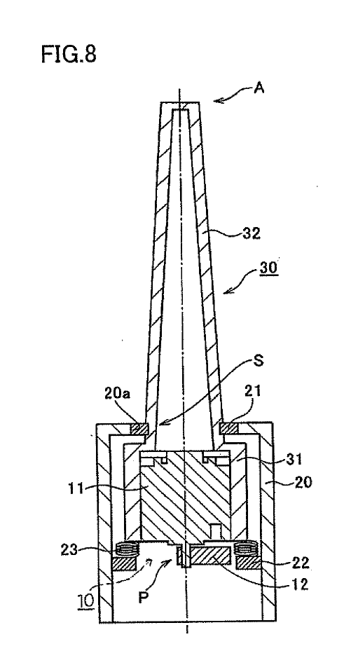

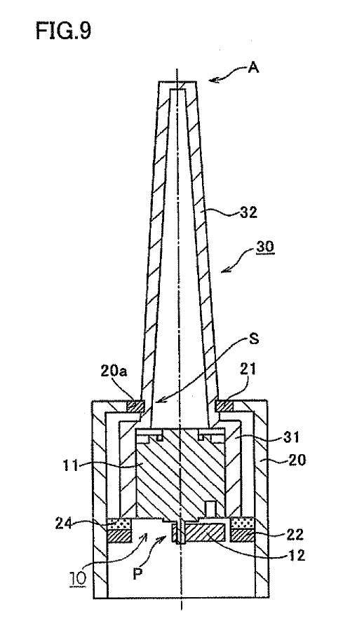

FIGS. 8 and 9 each show the third embodiment of the present invention. The present embodiment describes the configuration in which a vibration damping body for suppressing transmission of vibration of the vibration body to the case is additionally provided between the vibration body and the annular member (member serving as a position restricting portion). Since other configurations and operations are the same as those in the first embodiment, the same components are designated by the same reference characters, and the description thereof will not be repeated.

FIGS. 8 and FIG. 9 each are a schematic cross-sectional view showing a main component part of the electric toothbrush according to the third embodiment of the present invention.

As described in the first embodiment, case 20 has an inner peripheral surface provided with annular member 22 for restricting movement of vibration body 30 toward the one end side. This annular member 22 serves to restrict movement of vibration body 30 toward the one end side while permitting vibration of vibration body 30. Although this annular member 22 permits vibration of vibration body 30, the vibration of vibration body 30 is directly transmitted to annular member 22 when employing the configuration in which the movement of vibration body 30 is restricted by the structure that annular member 22 is in direct contact with vibration body 30. Consequently, significant vibration may be transmitted to case 20 through annular member 22.

The user feels uncomfortable when vibration occurs in case 20 gripped by a hand during toothbrushing. Accordingly, it is generally undesirable that case 20 is vibrated. Thus, the present embodiment employs the configuration in which a vibration damping body for suppressing transmission of the vibration of vibration body 30 to case 20 is provided between annular member 22 and vibration body 30. FIG. 8 shows an example in which a spring 23 is employed as a vibration damping body. FIG. 9 shows an example in which a vibration energy absorber (for example, gel-like material) 24 is employed as a vibration damping body. It is to be noted that the vibration damping body is not limited thereto but may be any component that can absorb vibration energy. As described above, in the present embodiment, a vibration damping body is provided between annular member 22 and vibration body 30 to form a vibration damping structure for suppressing transmission of the vibration of vibration body 30 to case 20.

As described above, in addition to the effects obtained in the above-described first embodiment, the present embodiment has an effect that vibration of case 20 can be suppressed. It is to be noted that the present embodiment shows the configuration in which a vibration damping body is provided so as to be in contact with cylindrical portion 31 in vibration body 30, thereby suppressing transmission of vibration of vibration source 10 to case 20. However, it is also possible to employ the configuration in which a vibration damping body is provided so as to be in direct contact with vibration source 10 (motor 11), thereby suppressing transmission of vibration of vibration source 10 to case 20.

### Fourth Embodiment

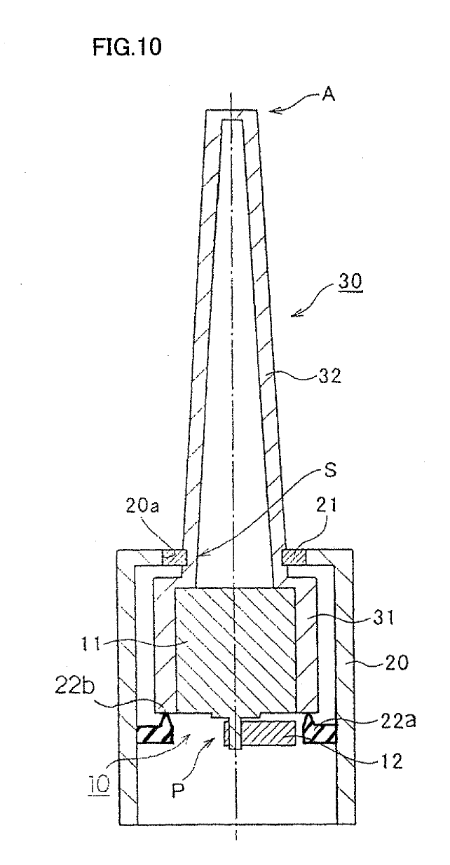

FIG. 10 shows the fourth embodiment of the present invention. The above-described third embodiment shows that a vibration damping structure is formed by providing a vibration damping body between the annular member and the vibration body, whereas the present embodiment shows that a vibration damping structure is formed by providing an annular member with a vibration damping function. Since other configurations and operations are the same as those in the first and third embodiments, the same components are designated by the same reference characters, and the description thereof will not be repeated.

FIG. 10 is a schematic cross-sectional view showing the main component part of the electric toothbrush according to the fourth embodiment of the present invention. As shown in the figure, the present embodiment provides a configuration in which an annular member 22a includes a plurality of conical protrusions 22b which protrude toward the other end side and have tips in contact with vibration body 30. It is to be noted that these conical protrusions 22b are provided at regular intervals in the circumferential direction. Furthermore, annular member 22a according to the present embodiment is made of hard elastomer material and has a function of damping vibration by itself. Thus, in the present embodiment, annular member 22a itself has a function of damping vibration, to thereby form a vibration damping structure for suppressing transmission of the vibration of vibration body 30 to case 20.

As described above, in addition to the effects obtained in the above-described first embodiment, the present embodiment also has an effect that vibration of case 20 can be suppressed as in the case of the third embodiment. It is to be noted that the present embodiment shows the configuration in which conical protrusions 22b in annular member 22a are provided so as to be in contact with cylindrical portion 31 in vibration body 30, thereby suppressing transmission of vibration of vibration source 10 to case 20. However, it is also possible to employ the configuration in which conical protrusions 22b in annular member 22a are provided so as to be in direct contact with vibration source 10 (motor 11), thereby suppressing transmission of vibration of vibration source 10 to case 20. Furthermore, the present embodiment also shows the configuration in which a plurality of conical protrusions 22b are provided at regular intervals in the circumferential direction. However, the important requirement is to make it difficult to transmit the vibration of vibration source 10 to the annular member. Accordingly, the area coming into contact with vibration source 10 or vibration body 30 of the annular member only needs to be decreased. For example, it is also preferable to employ the configuration in which the annular member has annular protrusions protruding (each having a pointed tip) toward the other end side (annular protrusions provided concentrically with the annular member over the entire circumference) and the tip of each annular protrusion is in contact with vibration body 30 or vibration source 10.

### Fifth Embodiment

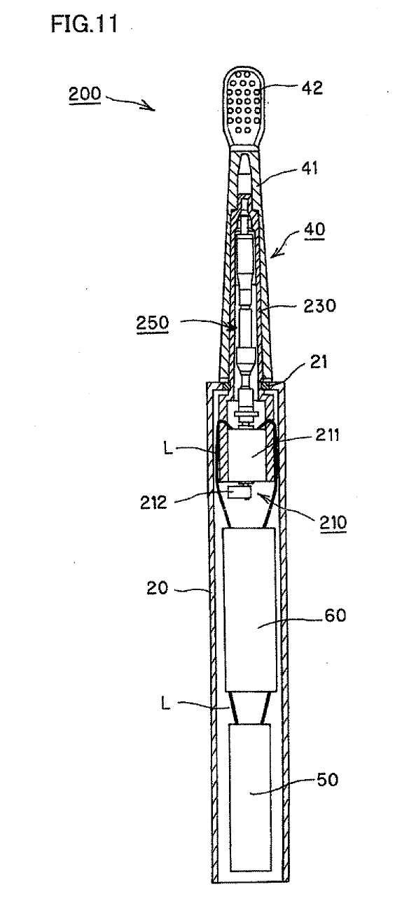

FIGS. 11 to 13 each show the fifth embodiment of the present invention. The present embodiment shows the configuration in which an eccentric shaft for directly vibrating the other end of the vibration body is additionally provided in the configuration in the above-described first embodiment. Since other configurations and operations are the same as those in the first embodiment, the same components are designated by the same reference characters, and the description thereof will not be repeated.

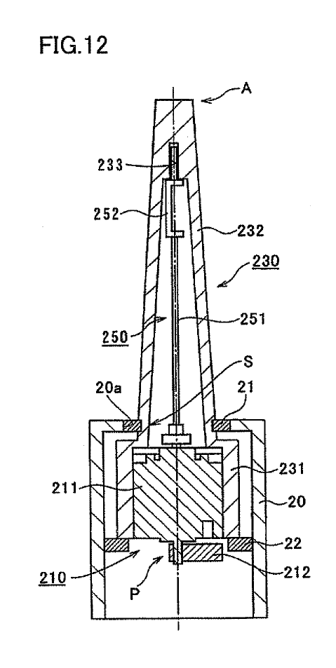

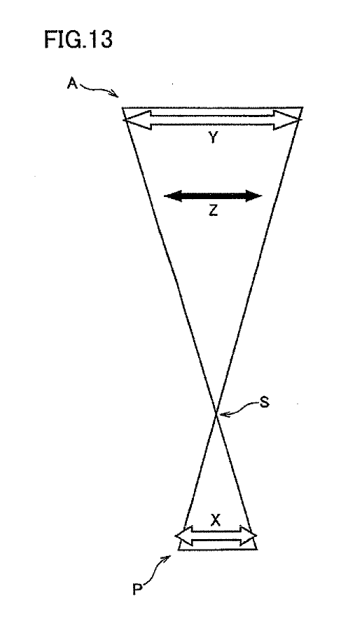

FIG. 11 is a diagram of an internal configuration of an electric toothbrush according to the fifth embodiment of the present invention. FIG. 12 is a schematic cross-sectional view showing a main component part of the electric toothbrush according to the fifth embodiment of the present invention. FIG. 13 is a diagram for illustrating the state of vibration transmission in the electric toothbrush according to the fifth embodiment of the present invention.

Also in an electric toothbrush 200 according to the present embodiment, as in the case of the above-described first embodiment, a vibration body 230 includes a cylindrical portion 231 and a tapered portion 232, in which a vibration source 210 including a motor 211 and a weight 212 is provided in cylindrical portion 231 on the one end side of vibration body 230.

Furthermore, an eccentric shaft 250 is provided in the present embodiment. This eccentric shaft 250 is configured to be rotated by motor 211. In other words, in the present embodiment, motor 211 that is a component of vibration source 210 also serves as a driving source for rotating eccentric shaft 250. It is to be noted that eccentric shaft 250 includes a shaft body 251 and a weight 252 fixed to shaft body 251 and having the center of gravity located in the position displaced from the shaft center. In this case, weight 252 is configured to have the center of gravity located in the position displaced by 180° from the center of gravity of weight 212 included in vibration source 210 with respect to the rotation center in terms of design.

Furthermore, in the present embodiment, a bearing 233 is provided near the tip on the other end side of hollow tapered portion 232 in vibration body 230. Eccentric shaft 250 is fixed at its one end side to motor 211 and supported at the other end side by this bearing 233.

When electric toothbrush 200 according to the present embodiment is powered on, the operation caused by vibration of vibration source 210 similar to that in the above-described first embodiment is performed. In the present embodiment, when electric toothbrush 200 is powered on, eccentric shaft 250 is also rotated. As described above, eccentric shaft 250 is provided with weight 252 having the center of gravity located in the position displaced from the shaft center. Accordingly, if eccentric shaft 250 is rotated in the state where the tip of eccentric shaft 250 is not supported by bearing 233, eccentric shaft 250 is pivotally moved around the shaft center while eccentric shaft 250 itself rotates. Consequently, eccentric shaft 250 is rotated in the state where eccentric shaft 250 is supported by bearing 233, which allows the operation to be performed in such a manner that the outer wall surface near the tip of eccentric shaft 250 repeatedly strikes against the inner wall surface of bearing 233 a number of times for a short time period.

When the above-described operation is performed, the portion around the other end of vibration body 230 provided with bearing 233 can be vibrated directly through bearing 233. Then, when vibration body 230 is vibrated, the vibration can be transmitted to brush part 40.

As described above, according to the present embodiment, the vibration of vibration source 210 can be amplified and transmitted to the other end (near brush 42) of vibration body 230, and the portion around the other end of vibration body 230 can also be vibrated directly by eccentric shaft 250. It is to be noted that a reference character Z shown in FIG. 13 schematically shows the state where vibration body 230 is vibrated directly by eccentric shaft 250. Therefore, electric toothbrush 200 according to the present embodiment allows the other end side of vibration body 230 to be further greatly vibrated as compared to each of the above-described embodiments. Furthermore, in the present embodiment, the center of gravity of weight 252 is located in the position displaced from the center of gravity of weight 212 included in vibration source 210 by 180° with respect to the rotation center in terms of design. Therefore, the other end side of vibration body 230 can be effectively vibrated without damping of the vibration caused by each of vibration source 210 and eccentric shaft 250.

### Sixth Embodiment

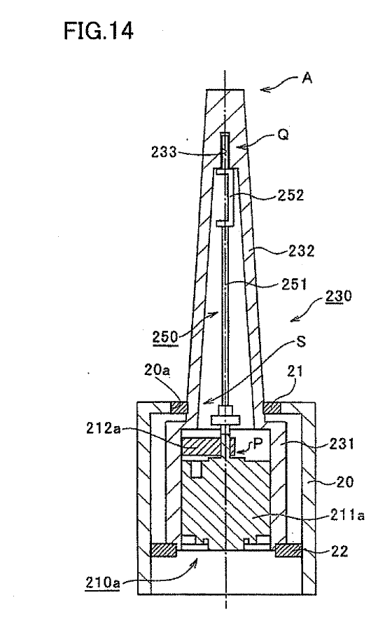

FIG. 14 shows the sixth embodiment of the present invention. The above-described fifth embodiment shows that a weight is provided on the one end side of the motor, whereas the present embodiment shows that a weight is provided on the other end side of the motor. Since other configurations and operations are the same as those in the fifth embodiment, the same components are designated by the same reference characters, and the description thereof will not be repeated.

FIG. 14 is a schematic cross-sectional view showing the main component part of an electric toothbrush according to the sixth embodiment of the present invention.

Also in the present embodiment, a vibration source 210a includes a motor 211a fixed in the state where it is inserted into cylindrical portion 231 in vibration body 230 and a weight 212a attached to the rotation shaft of motor 211a. The present embodiment is different from the above-described fifth embodiment only in that weight 212a is provided on the other end side of motor 211a. It is to be noted that the present embodiment is identical to the above-described first embodiment in that the center of gravity of weight 252 of eccentric shaft 250 is located in the position displaced from the center of gravity of weight 212a included in vibration source 210a by 180° with respect to the rotation center in terms of design.

It is needless to say that the above-described configuration allows the effects similar to those obtained in the above-described fifth embodiment to be achieved also in the present embodiment.

### Seventh Embodiment

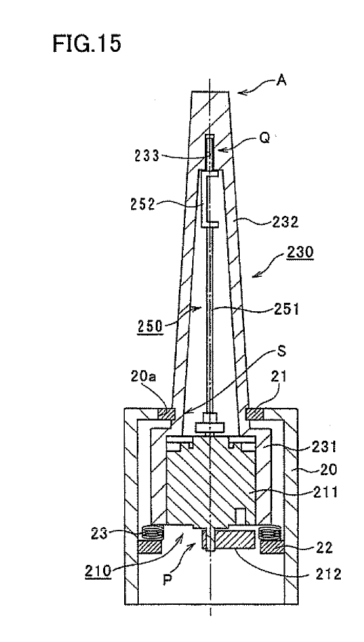

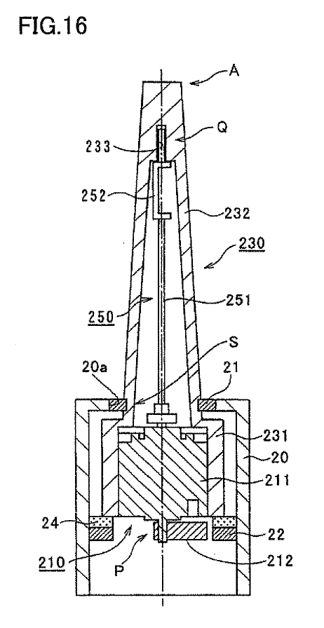

FIGS. 15 and 16 each show the seventh embodiment of the present invention. The present embodiment shows the configuration in which a vibration damping body for suppressing transmission of vibration of the vibration body to the case is additionally provided between the vibration body and the annular member (member serving as a position restricting portion) in the configuration in the above-described fifth embodiment. Since other configurations and operations are the same as those in the fifth embodiment, the same components are designated by the same reference characters, and the description thereof will not be repeated.

FIGS. 15 and 16 each are a schematic cross-sectional view showing the main component part of the electric toothbrush according to the seventh embodiment of the present invention.

As in the third embodiment, the present embodiment employs the configuration in which a vibration damping body for suppressing transmission of the vibration of vibration body 230 to case 20 is provided between annular member 22 and vibration body 230. FIG. 15 shows an example in which spring 23 is employed as a vibration damping body. FIG. 16 shows an example in which vibration energy absorber (for example, gel-like material) 24 is employed as a vibration damping body. It is to be noted that the vibration damping body is not limited thereto but may be any component that can absorb vibration energy.

As described above, in addition to the effects obtained in the above-described fifth embodiment, the present embodiment has an effect that the vibration of case 20 can be suppressed. It is to be noted that the present embodiment shows the configuration in which the vibration damping body is provided so as to be in contact with cylindrical portion 231 in vibration body 230, thereby suppressing transmission of the vibration of vibration source 210 to case 20. However, it is also possible to employ the configuration in which the vibration damping body is provided so as to be in direct contact with vibration source 210 (motor 211), thereby suppressing transmission of the vibration of vibration source 210 to case 20. Furthermore, as shown in the above-described fourth embodiment, it is also possible to employ the configuration in which the vibration is suppressed by providing the annular member itself with a function of damping the vibration.

### DESCRIPTION OF THE REFERENCE SIGNS

10, 10a vibration source, 11, 11a motor, 12, 12a weight, 20 case, 20a opening, 21 support member, 22, 22a annular member, 22b conical protrusion, 23 spring, 24 vibration energy absorber, 30 vibration body, 31 cylindrical portion, 32 tapered portion, 40 brush part, 41 body part, 42 brush, 50 battery, 60 circuit board, 100, 100a electric toothbrush, 200 electric toothbrush, 210, 210a vibration source, 211, 211a motor, 212, 212a weight, 230 vibration body, 231 cylindrical portion, 232 tapered portion, 233 bearing, 250 eccentric shaft, 251 shaft body, 252 weight, L wiring line.

1. An electric toothbrush comprising:
a cylindrical case; and
a vibration body having one end located within the case and an other end provided so as to protrude through an opening at a tip of the case to outside of the case, and vibrating a brush located in proximity to the other end,
said vibration body being provided with a vibration source on said one end side and having an outer peripheral surface supported in a position close to the vibration source side with respect to a midpoint in a longitudinal direction of the vibration body.

2. The electric toothbrush according to claim 1, wherein said vibration source includes a motor fixed on said one end side of said vibration body and a weight attached to a rotation shaft of the motor and having a center of gravity in a position displaced from a rotation center of the rotation shaft.

3. The electric toothbrush according to claim 2, wherein said weight is attached to said one end side of said motor.

4. The electric toothbrush according to claim 1, wherein a position restricting portion for restricting movement of the vibration body toward said one end side while permitting vibration of said vibration body is provided within said case.

5. The electric toothbrush according to claim 1, wherein a vibration damping structure for suppressing transmission of vibration of said vibration source to the case is provided within said case.

6. The electric toothbrush according to claim 1, comprising:
an eccentric shaft including a shaft body and a weight fixed to the shaft body and having a center of gravity located in a position displaced from a shaft center; and
a driving source rotating the eccentric shaft,
said vibration body including a hollow member, a bearing being provided in proximity to a tip on said other end side within the hollow member, and said eccentric shaft being supported by the bearing.

7. The electric toothbrush according to claim 6, wherein the center of gravity of the weight of said eccentric shaft is located in a position displaced by approximately 180° from the center of gravity of the weight included in said vibration source with respect to the rotation center.
